(19) United States
(12) Patent Application Publication
(10) Pub. No.: US 2011/0024104 A1
(43) Pub. Date: Feb. 3, 2011

(54) THREE PHASE ELECTRICAL WET CONNECTOR FOR A DOWNHOLE TOOL

(75) Inventor: Neil Griffiths, Houston, TX (US)

Correspondence Address: OSHA LIANG L.L.P., TWO HOUSTON CENTER, 909 FANNIN, SUITE 3500, HOUSTON, TX, 77010, US

(73) Assignee: Zeitecs B.V. (NL), Rijswijk (NL)

(21) Appl. No.: 12/533,896

(22) Filed: Jul. 31, 2009

(51) Int. Cl. E21B 43/00; H01R 4/60; B23P 11/00

(52) U.S. Cl. 166/105; 439/190; 29/428

(57) ABSTRACT

An electrical connector for a downhole tool the connector including a static connector part coupled to a production tubing, the static connector part having a static connector base, and a plurality of connector members disposed on the static connector base and extending axially upward therefrom, a moveable connector part configured to engage the static connector part, the moveable connector part including, a moveable connector base, a plurality of corresponding connector members disposed on the moveable connector base and extending axially downward therefrom and configured to engaged the plurality of connector members disposed on the static connector base, wherein the plurality of connector members are clustered on the static connector base and the plurality of corresponding connector members are clustered on the moveable connector base is disclosed, and at least one fluid flow path formed radially outward of the clustered and engaged connector members.

### BACKGROUND OF INVENTION

1. Field of the Invention

Embodiments disclosed herein generally relate to a connector for a downhole tool that requires electrical power. More specifically, embodiments disclosed herein relate to a wet mateable connector for a downhole tool. Further, embodiments disclosed herein relate to a connector for an electrical fluid transducer system.

2. Background Art

Downhole tools that require electrical power for proper functioning downhole typically require electrical connectors that may be mated downhole for completing an electrical connection between the components. Specifically, a tool disposed in the wellbore that requires electrical power for use, may be connected to an electrical power source at the surface by running a power cable into the wellbore and connecting an electrical connector to the downhole tool.

Subterranean electrical fluid transducer systems are typically disposed and retrieved from downhole on jointed tubing. However, these systems may also be run on wireline or wire rope. For example, electric submersible pumps (ESP) and downhole gas compressors may require electrical power downhole. ESP systems are known in the art for providing artificial lift in producing hydrocarbons and/or water. An ESP system may include a pump, sealing elements, and a motor and may be run downhole on jointed tubing, coiled tubing, or wireline.

A wireline retrievable ESP typically includes a wet mateable electrical connector that allows retrieval of the ESP system to the surface for maintenance, inspection, or replacement, without the need to simultaneously pull the electrical power supply cable to surface. The electrical connection of the retrievable ESP is made downhole, thereby preventing damage to the power supply cable which may occur in systems where the power supply cable is removed. The connection includes a three phase high voltage connection system of which one half is permanently deployed in the well and the other half is deployed with the ESP. Before production commences, the wireline may be detached and retrieved.

One example of a wet mateable electrical connector known in the art is disclosed in International patent publication WO 01/02699 (“the '699 publication”). The '699 publication discloses a wet mateable electrical connector that includes axially spaced pairs of electrical contact rings that are concentric with the wellbore. After retrieval of the ESP, the electrical contact rings of the connector of the '699 publication prevents access to the wellbore beneath.

U.S. Publication No. 2007/0275585 (“the '585 publication”) provides another example of a wet mateable electrical connector for electrically connecting an electrical downhole tool. As disclosed, the connector of the '585 publication includes a static connector part and a moveable connector part. The static connector part includes an annular housing having a central throughbore and a set of three box members, while the moveable connector part includes a set of three pin members configured to engage the three box members, thereby electrically connecting the electrical downhole tool system.

Accordingly, there exists a need for a wireline retrievable electrical downhole tool that provides improved alignment and spacing of electrical connectors, prevention of movement and rotation of the tool, access to the wellbore below the tool, and improved fluid flow.

### SUMMARY OF INVENTION

In one aspect, embodiments disclosed herein relate to an electrical connector for a downhole tool the connector including a static connector part coupled to a production tubing, the static connector part having a static connector base, and a plurality of connector members disposed on the static connector base and extending axially upward therefrom, a moveable connector part configured to engage the static connector part, the moveable connector part including, a moveable connector base, a plurality of corresponding connector members disposed on the moveable connector base and extending axially downward therefrom and configured to engaged the plurality of connector members disposed on the static connector base, wherein the plurality of connector members are clustered on the static connector base and the plurality of corresponding connector members are clustered on the moveable connector base is disclosed, and at least one fluid flow path formed radially outward of the clustered and engaged connector members.

In another aspect, embodiments disclosed herein relate to a method for interconnecting electrical conduits in an borehole, the method including installing a static connector part substantially coaxially within the borehole, aligning connector members of a moveable connector part with corresponding connector members of the static connector part and aligning at least one fluid flow path formed radially outward of the aligned connector members, and lowering the movable connector part into engagement with the static connector part, such that the connector members engage and electrical contacts intermesh.

In another aspect, embodiments disclosed herein relate to an electric fluid transducer system including a retrievable pumping apparatus including a motor, a pump, and a moveable connector part having centrally located electrical contacts, a corresponding downhole receiving apparatus including a static connector part having centrally located electrical contacts configured to engage the electrical contacts of the moveable connector part, wherein at least one fluid flow path is formed radially outward of the electrical contacts, and a power supply cable operatively coupled between the downhole receiving apparatus and a surface power supply.

Other aspects and advantages of the invention will be apparent from the following description and the appended claims.

### BRIEF DESCRIPTION OF DRAWINGS

FIG. 1 is a schematic three-dimensional view of an ESP system and a self-cleaning downhole electrical connector in accordance with embodiments disclosed herein.

FIG. 2 is cross-sectional view of an ESP system and a downhole electrical connector in accordance with embodiments disclosed herein.

FIGS. 2A-2D show cross-sections of the ESP system and downhole electrical connector shown in FIG. 2

### DETAILED DESCRIPTION

Embodiments disclosed herein generally relate to a connector for a downhole tool that requires electrical power. More specifically, embodiments disclosed herein relate to a wet mateable connector for a downhole tool. Further, embodiments disclosed herein relate to a connector for an electrical fluid transducer system.

In some embodiments, a connector in accordance with embodiments disclosed herein may be used with an electrical submersible pump (ESP) system. In other embodiments, a connector in accordance with embodiments disclosed herein may be used with a downhole gas compressor. One of ordinary skill in the art will appreciate that a connector in accordance with embodiments disclosed herein may be used with any downhole tool that requires an electrical connection, and is not limited to examples provided herein.

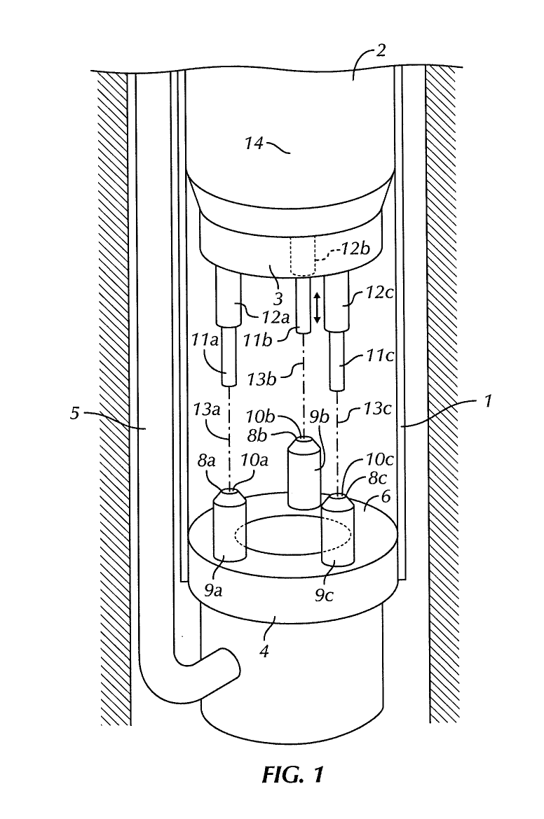

FIG. 1 shows a production tubing 1 of an oil production well into which an ESP system 2, having an ESP and electrical motor assembly, is suspended from a wireline (not shown). The production tubing may be disposed in a substantially vertical or inclined borehole.

A moveable part 3 of a downhole electrical connector according to the invention is connected to the electrical motor (not shown) of the ESP system 2 and is located just above a static part 4 of the downhole electrical connector according to the invention.

The static connector part 4 is mounted at a lower end of the production tubing 1 and is secured to a power supply cable string 5 which is suspended next to or external to the production tubing 1 and to which electrical power may be supplied by an electrical power source (not shown) at the earth surface.

The static connector part 4 includes an annular housing 6 in which a central throughbore 7 is arranged, and a set of three box sections 8A, 8B and 8C extends up from the annular housing 6. Each box section 8A-C is arranged in a sealed chamber 9A-C, which each includes an entrance opening 10A-C in which a seal is arranged which inhibits contact between a dielectric fluid within the chamber 9A-C and borehole fluids in the interior of the production tubing 1.

The moveable connector part 3 comprises a set of three pin members 11A-C, which are configured to penetrate through the seals into the box sections 8A-C, such that when the connector parts 3 and 4 have been joined, any electrically conducive parts of the pin members 11A-C are arranged within the sealed chambers 9A-C and are not in contact with the borehole fluids.

The pin members 11A-C may be arranged in protective sleeves 12A-C or a protective housing, which inhibits fouling of the pin members 11A-C during the descent into the wellbore. Additionally, sleeves or housings 12A-C are retracted by the lower connector part 4, thereby minimizing exposure of the pin members 11A-C to wellbore fluids.

The moveable and static connector part 3 and 4 are provided with an alignment assembly (not shown) with intermeshing axial grooves and guide pins (not shown) for accurate alignment of the pins 11A-C to the corresponding boxes 11A-C when the connector parts are engaged. As such, pins 11A-C slide along longitudinal axes 13A-C into the boxes 8A-C, which axes 13A-C are substantially parallel to a central axis 14 of the central throughbore 7 and of the production tubing 1.

The pin and box assemblies of the moveable and static connector parts 3 and 4 may be configured as disclosed in PCT Patent Application No. WO2002/082590, which is hereby incorporated by reference in its entirety.

One advantage of certain embodiments of the downhole electrical connector of the present disclosure is that it is self cleaning and that debris is not trapped between the connector parts 3 and 4 so that there is no requirement to flush a dielectrical fluid around the pin and box sections 8 and 11A-C to remove any fouling, debris and/or wellbore fluids therefrom.

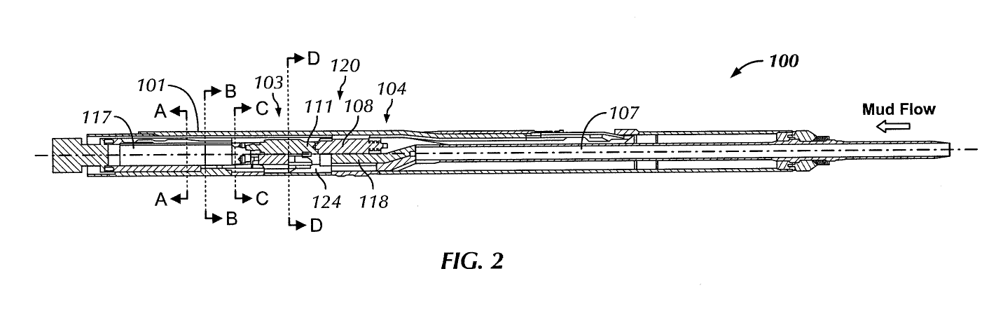

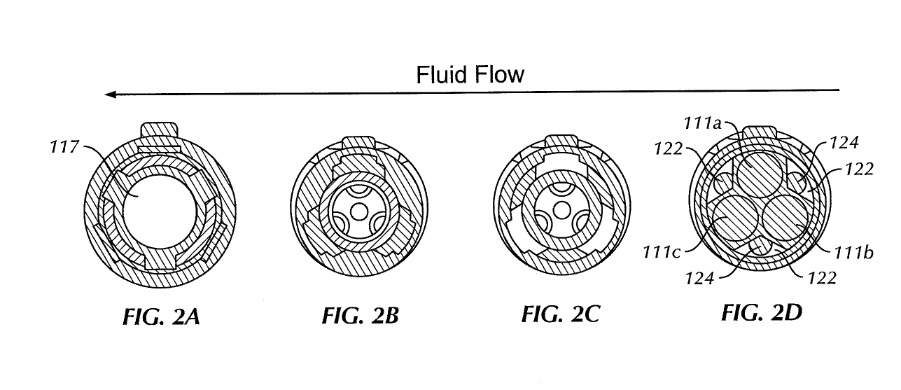

Referring now to FIG. 2, an alternate embodiment of an ESP assembly 100 having a wet mateable connector is shown. In this embodiment, a three phase wet mateable electrical connector 120 includes three connection points disposed towards an inner periphery of the production tubing 101, as discussed in more detail below. The ESP assembly 100 includes an ESP and electrical motor assembly (not shown), and is suspended from a wireline (not shown).

A moveable connector part 103 of downhole wet mateable electrical connector 120 is coupled to the electrical motor (not shown) of the ESP assembly 100, and is located above a static connector part 104 of the downhole electrical connector 120 according to embodiments disclosed herein. The static connector part 104 is mounted at a lower end of the production tubing 101 and is retrievably secured to a power supply cable string (not shown), which is suspended outside the production tubing 101, and to which electrical power may be supplied by an electrical power source (not shown) at the surface.

Referring to FIGS. 2 and 2A-2D together, the static connector part 104 includes a static connector base 118 having a plurality of upwardly facing connector members 108 disposed thereon. For example, in one embodiment, the connector members 108 may include a set of three box sections (not independently illustrated) extending upward from the static connector base 118. One of ordinary skill in the art will appreciate that an electrical connector having less than three electrical contacts or more than three electrical contacts may be used in accordance with embodiments disclosed herein without departing from the scope of embodiments disclosed herein.

The connector members 108 of static connector part 104 are disposed at the inner periphery of the production tubing 101 and may be evenly spaced apart. Specifically, the three connector members 108 are positioned toward the center of the production tubing 101, thereby providing a fluid flow path in a space 124 formed between outer surfaces of the connector members 108 and the inner surface of the production tubing 101. More specifically, the connector members 108 on the static connector base 104 are centrally clustered within the production tubing 101.

The moveable connector part 103 is disposed on a lower end of the motor (not shown) of the ESP assembly 100 and includes corresponding downwardly facing connector members 111. As shown, the connector members 108 of the static connector part 104 are configured to receive the corresponding connector members 111 of the moveable connector part 103. In one embodiment wherein the connector members 108 of the static connector part 104 include a set of three box sections, the corresponding connector members 111 of the moveable connector 103 may include a set of three pin members 111A-C (as shown in cross-section in FIG. 2D) extending downwardly into the borehole and configured to align with the three box sections of the static connector part 104 centrally positioned within annular housing 106.

Each box section may be arranged in a sealed chamber (not shown) that includes an entrance opening (not shown) in which a seal is arranged that inhibits contact between a dielectric fluid within the sealed chamber and borehole fluids in the interior of the production tubing 101. The three pin members 111A-C are configured to penetrate through the seals into the box sections (not independently illustrated), such that when the moveable and static connector parts 103 and 104 are engaged, any electrically conducive parts of the pin members 111A-C are arranged within the sealed chambers (not shown) of the connector members 108 and are not in contact with borehole fluids.

The pin members 111A-C may be arranged in protective sleeves (not shown) or a protective housing that inhibits fouling of the pin members 111A-C during the descent into the wellbore. In one embodiment, the protective sleeves or housings (not shown) may be moved by contact of the lower connector part 104 during engagement or coupling of the electrical connector 120, thereby minimizing exposure of the pin members 111A-C to wellbore fluids.

The moveable and static connector parts 103, 104 may be provided with an alignment assembly (not shown) with intermeshing axial grooves and guide pins (not shown) for accurate alignment of the connector members 108 and the corresponding connector members 111. For example, an alignment assembly may align pins 111A-C with the corresponding box sections (not independently illustrated) when the connector parts are being engaged. In this example, the pins 111A-C may slide along their longitudinal axes into the box sections, which axes are substantially parallel to a central axis 114 of the production tubing 101.

In an embodiment where the static connector part 104 includes three connector members 108 and the moveable static connector part 103 includes three corresponding connector members 111, three fluid flow paths may be formed radially outward of the centrally clustered and engaged connector members 108, 111. Specifically, as shown in FIG. 2D three channels or fluid flow paths 122 may be provided radially outward and between the engaged connector members 108, 111. In this embodiment, the engaged connector members 108, 111 are equally spaced apart at 120 degrees, and the three channels 122 are similarly spaced apart at 120 degrees. In other embodiments, there may be more than three equally spaced engaged connector members 108, 111, for example, four engaged connector members 108, 111 spaced at 90 degrees. In yet other embodiments, the engaged connector members 108, 111 may not be evenly spaced. In still other embodiments, the connector members 108, 111 may be clustered together, but not centrally clustered within the production tubing 101. In such an embodiment, the connector members 108, 111 may be clustered to one side of the electrical connection, and one or more fluid flow paths or channels 122 may be provided proximate clustered connector members 108, 111.

During operation, production fluid flows upward through a central throughbore 107 and is forced outward around the static connector part 104 through flow paths 122 formed in the static connector base 118 of the static connector part 104, as shown in FIGS. 2A-2D. The flow paths 122 formed in the static connector base 118 may include grooves or channels formed axially through the static connector base 118 of the static connector part 104 to fluidly connect the central throughbore 107 to the spaces 124 formed between the outer circumference of the engaged connector members 108, 111 and the inner surface of the production tubing 101.

As shown in FIGS. 2 and 2A-2D, as fluid, i.e., hydrocarbons, flow up through the connection, the fluid first enters center throughbore 107 (FIG. 2), flows centrally and then diverts radially outward through channels formed in the static connector base 118, then flows upward through the flow paths 122 defined by the spaces 124 radially outward of the static and moveable connectors 104, 103. One of ordinary skill in the art will appreciate that that one, two, three, or more flow paths 122 may be formed in the static connector base 118, depending on, for example, the number of connector members 108, 111, spacing of the connector members 108, 111, and the size of the connection.

Advantageously, embodiments disclosed herein provide a wet mateable electrical connector that includes connector members that are centrally clustered to provide flow paths or channels radially outward of the clustered connector members within the production tubing. In some embodiments, a wet mateable electrical connector includes three mating connector portions (i.e., box and pin members) that are centrally clustered within a housing or production tubing, thereby allowing fluid flow around an outer periphery of the engaged mating connector members of the electrical connector.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed:

1. An electrical connector for a downhole tool, the connector comprising:
a static connector part coupled to a production tubing, the static connector part comprising:
a static connector base; and
a plurality of connector members disposed on the static connector base and extending axially upward therefrom;
a moveable connector part configured to engage the static connector part, the moveable connector part comprising:
a moveable connector base; and
a plurality of corresponding connector members disposed on the moveable connector base and extending axially downward therefrom and configured to engaged the plurality of connector members disposed on the static connector base,
wherein the plurality of connector members are clustered on the static connector base and the plurality of corresponding connector members are clustered on the moveable connector base; and
at least one fluid flow path formed radially outward of the clustered and engaged connector members.

2. The electrical connector of claim 1, wherein the connector members and the corresponding connector members are centrally clustered.

3. The electrical connector of claim 1, wherein at least one connector member is a box member.

4. The electrical connector of claim 3, wherein the box members are spaced equally.

5. The electrical connector of claim 3, wherein the box member comprises a sealed chamber.

6. The electrical connector of claim 5, wherein the sealed chamber comprises a dielectric fluid.

7. The electrical connector of claim 1, wherein at least one corresponding connector member is a pin member, and wherein the at least one pin member further comprises a protective sleeve disposed thereon.

8. The electrical connector of claim 1, further comprising a power supply cable coupled to the static connector base.

9. The electrical connector of claim 1, further comprising an alignment assembly.

10. A method for interconnecting electrical conduits in an borehole, the method comprising:
installing a static connector part substantially coaxially within the borehole;
aligning connector members of a moveable connector part with corresponding connector members of the static connector part and aligning at least one fluid flow path formed radially outward of the aligned connector members; and
lowering the movable connector part into engagement with the static connector part, such that the connector members engage and electrical contacts intermesh.

11. The method of claim 10, further comprising moving a protective sleeve of the corresponding connector members of the moveable connector part.

12. An electric fluid transducer system comprising:
a retrievable pumping apparatus comprising:
a motor;
a pump; and
a moveable connector part having centrally located electrical contacts;
a corresponding downhole receiving apparatus comprising:
a static connector part having centrally located electrical contacts configured to engage the electrical contacts of the moveable connector part,
wherein at least one fluid flow path is formed radially outward of the electrical contacts; and
a power supply cable operatively coupled between the downhole receiving apparatus and a surface power supply.

13. The electric fluid transducer system of claim 12, wherein the retrievable pumping apparatus is coupled to a wireline.

14. The electric fluid transducer system of claim 12, further comprising an alignment assembly.
